(19) United States
(12) Patent Application Publication
(10) Pub. No.: US 2017/0135387 A1
(43) Pub. Date: May 18, 2017

(54) Rotary Molded Shaped Crunchy Granola Food Products And Methods Of Making Same

(71) Applicant: KELLOGG COMPANY, Battle Creek, MI (US)

(72) Inventors: Thomas Z. TREECE, Altamonte Springs, FL (US); Constance Jo ENEVOLD, Augusta, MI (US); Donald BARNES, Battle Creek, MI (US); Eric C. SULOFF, Portage, MI (US); Tamara A. REICHKITZER, Battle Creek, MI (US)

(21) Appl. No.: 15/319,227

(22) PCT Filed: Jun. 19, 2015
(86) PCT No.: PCT/US2015/036670

§ 371 Date: Dec. 15, 2016

Related U.S. Application Data
(60) Provisional application No. 62/014,448, filed on Jun. 19, 2014.

(51) Int. Cl. A23L 7/126; A23L 29/212; A23L 29/25; A23L 29/10

(52) U.S. Cl. CPC A23L 7/126; A23L 29/10; A23L 29/212; A23L 29/25; A23V 2002/00

(57) ABSTRACT

Disclosed are nonlimiting embodiments comprising a novel process for forming and shaping crunchy granola food products. The process comprises using rotary molding processes to form and shape a granola mass into a variety of desired shapes. The granola mass is able to be rotary molded as a result of use of a unique binder composition that comprises at least one of pre-gelatinized starch or hydrocolloid gum in the binder composition. The pre-gelatinized starch and/or hydrocolloid gum enables the binder viscosity to increase and increases the tackiness of the granola mass such that it can be formed by a rotary molder and such that it releases from the mold as a unitary piece of shaped and formed granola food product.

### CROSS REFERENCE TO RELATED APPLICATION

This PCT application claims the benefit of U.S. Provisional application No. 62/014,448, filed on Jun. 19, 2014. The entire contents of the aforementioned application are hereby incorporated by reference in their entirety.

### TECHNICAL FIELD

Some embodiments relate generally to granola type food products and, more particularly, to shaped crunchy granola type food products that are shaped and formed using a rotary molding process.

### BACKGROUND

Granola is a well-known product category that usually comprises a variety of grains and other edible large food particulates bound together using a liquid binder comprising water, edible oil, sugars or sugar syrups, emulsifiers, and flavorings. In contrast with loose granola type mixes also known as trail mixes, nonlimiting embodiments herein comprise granola type food products that are bound together as bars, clusters, or other shaped products. Other components in a granola can typically include some combination of dry components such as, for example, grains, large edible particulates, nuts, seeds, fruit pieces or flakes, coconut flakes, and chocolate pieces. A typical process involves first mixing the components of the binder together to form the binder composition. Separately, the dry components are combined to form a dries mixture. Then the binder composition and the dries mixture are mixed together to form the granola mass. The mass is then generally formed into a slab by passing it through a series of compression rollers. The slab is then baked, cut to size then cooled and packaged.

Compression rollers can crush and tear up grains, especially flakes, grain bubbles like rice bubbles and other fragile edible particulates. The rollers can also break up fruit pieces, nuts, seeds and chocolate pieces. The cutting of the slab produces much waste product because the cut pieces, typically in a bar shape, often shatter and form non-uniform shapes that would be rejected by consumers so they are scrapped as waste. Sometimes the slab is baked whole and then broken into random pieces. Other times the binder composition and dries are mixed just enough to form clusters that are baked and packaged. These random shaped pieces have less waste but are also less desirable by consumers as a hand held item of food. The random shaped clusters find more use as an additive to ready-to-eat cereals. Consumers typically want a hand-held granola bar for eating convenience. The typical hand-held granola food products are shaped into flat rectangular type bar shapes. These shapes often have little novelty appeal to consumers.

It is desirable to provide a process for forming shaped granola food products into shapes that can be changed, have defined contours, and that can include embossing or more creative 3 dimensional shapes than a flat rectangle. It is also desirable to reduce product waste. It is desirable to create a process that allows for easy incorporation of puffed grains, whole rice bubbles (sometimes also known as “crisps”), flakes and other fragile grain or large edible particulate shapes that are retained throughout the forming and shaping process. Consumers typically want highly visible whole grains in granola food products for a natural appearance to their product. Manufacturers want a high speed and high throughput process that can be provided at a lower capital cost than typically involved in a compression roller line. Manufacturers also often want to reduce waste while being able to provide a variety of novel eating experiences.

### SUMMARY

Without limitation to only those embodiments expressly disclosed herein, and without waiving or disclaiming any embodiments or subject matter, some embodiments comprise a rotary molding process for forming shaped granola food products. The process involves the use of a binder composition that includes a pre-gelatinized starch (including but not limited to, pre-gelatinized grain flours having pre-gelatinized starch as a component) and/or hydrocolloid gum which enables formation of sufficient viscosity and tackiness to hold the granola components together and to permit their release as a unified piece from a rotary molder.

Without limitation, some embodiments comprise a method for formation of a shaped granola food product comprising the steps of: a) providing a binder composition comprising water and pre-gelatinized starch and/or hydrocolloid gum; b) combining the binder composition with grains, and optional sweeteners, additives, and oil to form a granola mix; and c) feeding the granola mix to a rotary molder and forming shaped granola food products using said rotary molder.

These and other features and advantages will become more apparent to those skilled in the art from the detailed description herein.

### DETAILED DESCRIPTION

Without limitation to only those embodiments expressly disclosed, and without waiving or disclaiming any embodiments or subject matter, some embodiments are directed toward rotary molded and shaped crunchy granola food products, including without limitation, use of a rotary molding process to form the shape of the granola food product. Rotary molding processes and the equipment to run the process is less expensive than the cost for a compression roller line for granola formation. Rotary molding machines and process lines are well-known in the art and thus will be described herein only in general terms. The process of some embodiments does not require undue modification of the standard rotary molding lines such as used to create cookies or crackers. There is very little waste in a rotary molding process for formation of granola food products because the final shape is formed from the malleable granola mix prior to baking of the mix into the hard crunchy granola food product. There is reduced or eliminated possibility of the food shattering during any cutting process. The rotary molding process also allows for many different types of shapes and sizes to be made: as nonlimiting examples, rectangles like current slab bars, shapes that are embossed on top, round shapes, oval shapes, square shapes, jigsaw piece shapes, shapes with cutout holes, or any sort of shape desired. In accordance with some embodiments, the process can be used to make shapes as small as ready-to-eat cereal and/or cereal additives and bars that have dimensions as large as 4 inches by 3 inches by ⅜ inch thick or even larger.

As one nonlimiting example of a rotary molding process, two rotating drums have a hopper above that is loaded with a dough of interest. One drum has a shape of interest as a mold. The dough from the hopper is dropped into the cavity of the drum, where it is pressed into the mold shape of interest by the other drum. As the drum rotates through the 6 o'clock position, the shaped dough exits from the drum onto a belt or other conveyor, after which the shaped dough is typically moved for further processing.

In the past, rotary molding processes have been used for high speed production of cookies and crackers using standard rotary molding devices. In these processes, the doughs used are quite dry and have low to no sugar syrup levels. Moreover, they also may contain very small particulates in the form of milled flours of grains. Thus, these doughs are easy to mold in a rotary molding process as they are cohesive and very malleable. By way of contrast, some embodiments are directed to rotary molding of granola which has large particulates and which does not form a typical cohesive dough. Granola is more of an agglomeration of large particulates rather than a dough. Granola typically has many different components so it is very hard to form a malleable cohesive mass.

The present inventors have found unexpectedly that use of a pre-gelatinized starch and/or hydrocolloid gum in the binder composition permits use of a rotary molding process that makes granola-type foods. The inventors have also found that in some embodiments, without limitation, a multi-stage mixing process wherein an oil portion is optionally added to the formulation at two stages enhances production of a cohesive granola mass that will both flow into a rotary molder for shaping and then release from the mold as a cohesive unitary shaped mass. The pre-gelatinized starch and/or hydrocolloid gum acts to both increase the viscosity of the binder composition and to increase the tackiness. In some nonlimiting embodiments, these two effects are believed to result in a granola mass that is cohesive to itself and malleable enough to form into the shapes in a rotary molder, and thus enhance the ability of the granola mass to form into the desired shape and to then release as a unitary piece from the mold. The inventors have also found that a plastic rotary molder surface is preferred for better release from the mold onto the transfer belt; however, other surface types can be used, as nonlimiting examples, a coated metal such as a Teflon-coated metal, or a non-coated metal. Once molded, the unitary shaped and formed granola pieces are transferred off the rotary molder and onto a conveyor system that transfers them to an oven to be baked. The baked shaped granola is a crunchy granola, as opposed to a cold formed granola which tends to be softer. The baked granola is cooled and then packaged.

The molded granola pieces can be coated with toppings prior to the baking step. These toppings might include particulates, as nonlimiting examples, bran pieces or nuts, or flavorings like cinnamon, sugar and other flavors. Once baked, the granola food pieces can also optionally be coated by bottom enrobing, fully enrobing, or have a topping drizzled onto the shapes. The coatings can be of any of the sorts know to those of skill in the art and include, by way of example, chocolate, milk chocolate, caramel, honey, nut butters, compound coatings comprising sugar and fat, or yogurt based coatings.

A number of important results flow from this newly developed process of some embodiments. One result is a dramatic decline in waste. Part of the reason is because the granola mass is fed from the hopper directly into a mold and there is no place for granola mass that does not end up in the mold to go other than back into the hopper. The formula provides for a granola mass that both fills the molds and releases as a unitary product so the level of rejects is low and virtually all formed food products can be used. The inventors have discovered surprisingly that one can use high levels of fragile pieces like puffed grains and rice bubbles (each also being sometimes known as “crisps”), with the original pieces passing through the process while retaining most if not all their original sizes and shapes. This finding also applies to other pieces such as fruit pieces, grain and fruit flakes and chips. The shapes produced are consistent for a given mold and this also cuts back on rejected food products. The molds can be created in virtually any shape to allow for very creative shaped granola food pieces to be made. These include, as described above, rounds, ovals, squares, irregular contoured shapes, embossed pieces, bars, pieces with cutout holes, and many other designs. Designs can be rapidly changed by changing the rotary mold roller. This can aid in manufacturing a variety of shapes on the same line. Alternatively, a given roller can be created with a variety of mold shapes on the roller. The process allows for formation of products that are solid enough to withstand dunking in hot beverages as a hand held food item. This is highly desired by consumers.

Table 2 provides ranges of typical components used in a granola mass prepared according to some nonlimiting embodiments; it should be understood, however, that these ranges are nonlimiting, and the range of any individual component can be adjusted as desired to accomplish a desired feature of the granola mass, as only some examples, as to taste (e.g., sweetness or spiciness), texture, additive/inclusion content, and workability. In some embodiments, without limitation, the process comprises initially mixing Stage 1 binder components together. As some nonlimiting examples, the mixing equipment may comprise a ribbon mixer, a pin mixer, and/or a Peerless single arm/single blade mixer; high or low speeds are judged relative to a maximum speed that does not unduly macerate or break down the integrity of the solid components, for example, the grains. Stage 1 binder components include the pre-gelatinized starch and/or hydrocolloid gum and a dispersing agent as components of a first mixture. In some embodiments, without limitation, dispersing components of the first mixture include water, and optionally oil, sugar syrup, flavoring, and/or emulsifier; generally, these optional components are desirably included in the formulation. Mixing is conducted to sufficiently disperse each particle of starch or gum prior to hydration with water. Stage 2 water can be mixed directly with Stage 1 pre-gelatinized starch and/or hydrocolloid gum in a mixer with more aggressive shear that can accomplish both dispersion and hydration in the same stage. In Stage 2, water is added as needed to the result of Stage 1 to form a second mixture. The leavening agent(s), salt, sugar syrups, preservatives, and vitamin/mineral additions are optional in the second mixture. Generally, the formulations desirably include salt and a vitamin/mineral addition. The leavening agent(s) can be included to aid in texture formation and pH adjustment of the final product. The Stage 2 mixture is again mixed on high for several minutes. In Stage 3, the grains are added to the Stage 2 formulation, forming a third mixture which has the bulk component of the granola mass; the leavening agent(s) are optional at this point also. Again, leavening agent(s) can be used to affect the texture and/or pH (for color management during baking) of the finished product. The Stage 3 formulation is mixed for a few minutes on low speed. It is preferable that the mixer type at this stage, as nonlimiting examples, a ribbon blender or single arm Peerless, provides gentle mixing with low shear in order to enhance protection of grain and other particulate integrity. Finally, in Stage 4, the optional sugar type sweeteners, an optional second oil addition, and optional additives and inclusions are added to the mixture and mixed to form a fourth mixture comprising the granola mass. The granola mass is then fed into the hopper of a rotary molder and the granola mass is molded using a standard rotary molding process.

Without limitation, some embodiments comprise the use of at least one, or both, of a pre-gelatinized starch and/or hydrocolloid gum in the binding composition. Typical sugar syrup granola binder is undesirable for use on some embodiments because the granola mass created with these typical binders does not properly release from the rotary molds. The pre-gelatinized starch and/or hydrocolloid gum builds viscosity and tackiness in the binder, which aids release from the rotary molds of a unitary granola food product. The pre-gelatinized starch can be any native starch or any modified starch. Typical starch sources that can be used include, by way of nonlimiting example, those from wheat, rice, corn, tapioca, potato, and cassava. Moreover, in some nonlimiting embodiments, because they contain pre-gelatinized starch as a component, pre-gelatinized grain flours, either from refined or whole grains, may be substituted in whole or in part for pre-gelatinized starch, and when doing so, the usage level of such pre-gelatinized grain flour is adjusted to deliver the same level of active pre-gelatinized starch. In some embodiments the pre-gelatinized starch is present in an amount of 0 to 10% by weight based on the total weight of the granola mass; more preferably at 2 to 10%; and most preferably at 3 to 6%. The hydrocolloid gum sources that can be used include, by way of nonlimiting example, those from microbial fermentation (xanthan gum), tree exudates (acacia), and other vegetative sources (locust bean gum, guar gum, and cellulosics, etc.). In some embodiments, hydrocolloid gum is present in an amount of 0-10% by weight based on the total weight of the granola mass; more preferably 0.05 to 5%; and most preferably 0.1 to 3%.

The term oil is used herein to include any edible oil, fat or shortening. The oil can be any edible oil or shortening, by way of example, any vegetable oil like canola oil, sunflower oil, soybean oil, corn oil, cottonseed oil, peanut oil, safflower oil, palm oil, coconut oil, rice bran oil, olive oil, and/or sesame oil. The oil can be any shortening based on these oils and/or any fractions of these oils. When oil is used, the optional first addition of oil preferably is in an amount of from 0.1 to 18% by weight based on the total weight of the granola mass; more preferably 5 to 15%; and most preferably from 5 to 12%. If a second addition of oil is used, the optional second addition of oil may be an amount of from 0.1 to 5%; more preferably from 0.5 to 4%; and most preferably from 0.5 to 3.5%.

Sugar syrups that can be used in some embodiments include, by way of example, those sourced from sugar, corn, rice, tapioca, honey, molasses, malt extract, brown rice syrup, brown sugar syrup, invert syrup, glucose syrup, cane juice syrup, evaporated cane juice, fruit juice, agave syrup, and natural and artificial high intensity sweeteners, by way of example, stevia, monk fruit, sucralose, and aspartame. The sugar syrup is optional and preferably present in an amount of from 0 to 20% by weight based on the total weight of the granola mass; more preferably from 0.5 to 10%; and most preferably from 1 to 9%.

Any sort of optional flavorings can be used as are typically found in granola products. Typical flavorings include vanilla, cocoa, chocolate, banana, peanut, nut butters, maple, honey, cinnamon, spices, herbs and botanicals. Flavorings not typically found in granola products can also be used, including but not limited to, savory/salty flavorings like capsaicin, mustard, and oleoresins. The flavorings can be any combination and are preferably present in an amount of from 0 to 7.5% by weight based on the total weight of the granola mass; more preferably from 0.1 to 5%; and most preferably from 0.1 to 3.0% by weight.

The optional emulsifier can be any used in typical baking processes and includes, by way of example only, lecithin, diacetyl tartaric ester of monoglyceride (DATEM), mono- and di-glycerides and sodium stearoyl lactylate. The emulsifier is preferably present in an amount of 0 to 0.5% by weight based on the total weight of the granola mass; more preferably 0.05 to 0.5%; and most preferably from 0.1 to 0.4%.

The optional leavening agents can be any sort if used at all. Typical useful leavening agents include, by way of nonlimiting example, sodium bicarbonate, ammonium bicarbonate, potassium bicarbonate, sodium aluminum sulphate, sodium acid pyrophosphate, monocalcium phosphate, and baking powder. The leavening agents can be added at one or more stages if desired. At each stage where used, the amount of leavening agent preferably comprises from 0 to 1% by weight based on the total weight of the granola mass; more preferably from 0.1 to 0.9%; and most preferably from 0.1 to 0.7%.

The sugar/sweeteners can be sourced from any known sources. These include, by way of example only, sucrose, glucose, fructose, honey, molasses and maltose. The preferred sugar is sucrose. For sweet flavored granola products, the sugar/sweetener is preferably present in an amount of from 4.5 to 25% by weight based on the total weight of the granola mass; more preferably from 7.5 to 23%; and most preferably from 10 to 20%. For savory flavored granola products, sugar/sweeteners are optional to suit the overall flavor profile and, where used, are preferably present in an amount of from 0 to 5% by weight based on the total weight of the granola mass; more preferably 1 to 4%; and most preferably from 2 to 3%.

The granola mass may also desirably include a variety of additives or inclusions. Additives or inclusions can include combinations of, by way of nonlimiting examples: fruit pieces preferably dried; fruit juice concentrates; fruit purees; vegetable pieces; nuts or nut meats; seeds; legumes, preferably dried; raisins; carob or chocolate chips; yogurt chips; compound coating chips; white chocolate; coconut flakes; broken ready to eat cereal pieces (as nonlimiting examples, rice bubbles or DX crisps); toffee; pretzel pieces; cheese pieces, preferably dried or crumbled; meat pieces, preferably dried (as nonlimiting examples, bacon bits), and other food pieces for flavor and novelty. The additives can also include additional sources of soluble fiber besides those found in the grains, these can include sources such as inulin, fructo-oligosaccharides, galacto-oligosaccharides, corn fiber, wheat fiber. The additives can include additional protein such as protein flakes, protein nuggets (sometimes known as “crisps”), protein concentrates, protein isolates from any sources including soy, whey, milk, egg, pea and legume. The additives can include hydrocolloids such as xanthan gum, guar gum, locust bean gum, acacia gum, alginates, and carrageenans. The additives can include cellulosics such as microcrystalline cellulose, methyl cellulose, ethyl cellulose, carboxymethylcellulose, and hydroxyl propyl methylcellulose. The additives can also include an optional additional quantity of pre-gelatinized starch, of the same nonlimiting examples as in paragraph 15. The additives and inclusions preferably comprise 0 to 35% by weight based on the total weight of the granola mass; more preferably from 5 to 25%; and most preferably from 5 to 20%.

Grains used in the granola can be from any source material and in any combination such as, by way of nonlimiting example: wheat, corn, rice, barley, oat, rye, triticale, quinoa, amaranth, waxy versions of same, or other grains. The grains can be in any form such as: whole, grits, steel cut, rolled, flaked, puffed, toasted, precooked, or pearled. Preferably, larger particulates, no smaller than what is typically found in a stone ground whole grain flour, are desired to maintain visibility of grains in the finished shaped granola food product of some embodiments. The total amount of grain preferably comprises from 20 to 65% by weight of the granola mass; more preferably from 25 to 60%; and most preferably from 30 to 60%.

Any sort of vitamin/mineral mix desired can be used in the granola mass. The vitamin/mineral mix is preferably present in an amount of from 0 to 3% by weight based on the total weight of the granola mass; more preferably from 0.1 to 3%; and most preferably from 0.2 to 2.5%.

Any other type of minor additive typically found in granola can be used in the granola mass, by nonlimiting example, natural or artificial preservatives. Where used, the minor additive is preferably present in an amount of from 0 to 3% by weight based on the total weight of the granola mass; more preferably from 0.02 to 2%; most preferably from 0.1 to 1%.

The rotary molding process can be used to make any sort of shape, as nonlimiting examples, rectangular, round, oval, embossed or a raised design on one side, big or small pieces, jigsaw pieces, pieces with cutout shapes, and sticks. The formed piece can also include score lines to form segmented bars. The process can be used to make bars that have dimensions as large as 4 inches by 3 inches by ⅜ inch thick or even larger. In accordance with some embodiments, the process can be used to make pieces as small as ready-to-eat cereal and/or cereal additives.

General nonlimiting formulation guidelines are given below in Table 2. Preferably, the binder should contain at least one water portion and pre-gelatinized starch and/or hydrocolloid gum; moreover, the addition of ingredients may occur at stages and/or ranges other than those set out in Table 2:

TABLE 2

| | | Broadest range | Better range | Best range |
|---|---|---|---|---|
| | | of percent by | of percent by | of percent by |
| | | weight based | weight based | weight based |
| Stage | Component | on total weight | on total weight | on total weight |
| Stage 1 | Oil | 0-18 | 5-15 | 5-12 |
| | At least one, | | | |
| | or both, of: | | | |
| | Pre-gelatinized | 0-10 | 2-10 | 3-6 |
| | starch | | | |
| | Hydrocolloid | 0-10 | 0.05-5 | 0.1-3 |
| | gum | | | |
| | Sugar syrup | 0-20 | .5-10 | 1-9 |
| | Flavorings | 0-7.5 | .1-5 | .1-3.0 |
| | Emulsifier(s) | 0-0.5 | .05-.5 | .1-.4 |
| Stage 2 | Water | 8-18 | 9-16 | 9-15 |
| | Leavening | 0-1 | .1-.9 | .1-.7 |
| | agent(s) | | | |
| | Salt | 0-2 | .1-1.3 | .15-1.2 |
| | Vitamins/ | 0-3 | .1-3 | .2-2.5 |
| | minerals | | | |
| | Minor additives | 0-3 | 0.02-2 | 0.1-1 |
| Stage 3 | Grains | 20-65 | 25-60 | 30-60 |
| | Leavening | 0-1 | .1-.9 | .1-.7 |
| | agent(s) | | | |
| Stage 4 | Sugar/ | 0-25 | 7.5-23 | 10-20 |
| | sweeteners | | | |
| | Additives/ | 0-35 | 5-25 | 5-20 |
| | inclusions | | | |
| | Oil | 0-5 | .5-4 | .5-3.5 |

### EXAMPLES

The following additional examples of some embodiments are provided without limiting the embodiments only to those expressly disclosed herein and without waiving or disclaiming any embodiments:

### Example 1

In accordance with some embodiments, a black currant walnut granola mass is made comprised of the following:

| | Ingredient | Weight % |
|---|---|---|
| STAGE 1 | Oil | 5-12 |
| | Emulsifier | .1-.4 |
| | Pre-gelatinized starch | 3-6 |
| | Mix 1.5 min on HIGH speed | |
| STAGE 2 | Sugar syrup comprising | 1-9 |
| | molasses, honey, and brown | |
| | rice syrup | |
| | Water | 9-15 |
| | Mix 4 min on LOW speed | |
| STAGE 3 | Flavorings comprising | .1-2.5 |
| | tea masala, cinnamon, | |
| | cardamom, and ginger | |
| | Salt | .15-1.2 |
| | Leavening | .1-.7 |
| | Grains comprising instant | 30-60 |
| | barley flakes, #5 oats, | |
| | rolled grain blend, | |
| | puffed millet, and puffed | |
| | organic sorghum | |
| | Mix 2.5 min on LOW speed | |
| STAGE 4 | Oil | .5-3.5 |
| | Sugar comprising dried | 10-20 |
| | cane syrup | |
| | Additives/inclusions | 5-20 |
| | comprising walnuts, crisps | |
| | comprising brown rice, | |
| | and freeze-dried currants | |
| | Mix 1.5 minute on LOW speed | |
| | Total | 100.00 |

The granola mass is thereafter shaped in a rotary molding process to a desired shape.

### Example 2

In accordance with some embodiments, a lentil curry granola mass is made comprised of the following:

| | Ingredient | Weight % |
|---|---|---|
| STAGE 1 | Oil | 5-12 |
| | Soy Lecithin | .1-.4 |
| | Emulsifier | |
| | Pre-gelatinized starch | 3-6 |
| | Mix 1.5 min on HIGH speed | |
| STAGE 2 | Sugar syrup comprising | 1-9 |
| | molasses and brown rice | |
| | syrup | |
| | Water | 9-15 |
| | Mix 4 min on LOW speed | |
| STAGE 3 | Additives comprising roasted | 5-10 |
| | dried peas and coconut powder | |
| | Flavorings comprising | 0.1-5.0 |
| | chili powder, curry | |
| | powder, ginger powder, | |
| | sweet basil leaves. | |
| | Leavening | .1-.7 |
| | Grain comprising instant | 30-60 |
| | barley flakes, #5 | |
| | oats, rolled grain | |
| | blend, puffed millet, and | |
| | puffed org. sorghum | |
| | Mix 2.5 min on LOW speed | |
| STAGE 4 | Oil | .5-3.5 |
| | Sugar comprising | 2-8 |
| | dried cane syrup | |
| | Crisps comprising | 5-20 |
| | brown rice | |
| | Salt | .15-1.2 |
| | Total | 100.00 |

The granola mass is thereafter shaped in a rotary molding process to a desired shape.

### Example 3

In accordance with some embodiments, a honey oat flax granola mass is made comprised of the following:

| | Ingredient | Weight % |
|---|---|---|
| STAGE 1 | Oil | 5-12 |
| | Natural anti-oxidant | 0.1-1.0 |
| | Emulsifier | .1-.4 |
| | Pre-gelatinized starch | 2-10 |
| | Mix 1 min HIGH | |
| STAGE 2 | Sugar syrup comprising | 1-9 |
| | molasses and honey | |
| | Flavoring comprising | .1-2.5 |
| | vanilla | |
| | Water | 9-15 |
| | Mix 6 min LOW | |
| STAGE 3 | Grains comprising rolled | 30-60 |
| | grain blend with Quinoa, | |
| | rolled #5 oats, and | |
| | quick oats | |
| | Additives comprising | 0-10 |
| | whole brown flax seed | |
| | and coconut | |
| | Salt | .15-1.2 |
| | Leavening agent | .1-.7 |
| | Mix 1.5 mm LOW | |
| STAGE 4 | Additives comprising | 1-10 |
| | brown rice crisps | |
| | Sugar comprising | 10-20 |
| | dried cane syrup | |
| | Oil | .5-3.5 |
| | Mix 1.5 min LOW | |
| | Total | 100.000 |

The granola mass is thereafter shaped in a rotary molding process to a desired shape.

### Example 4

In accordance with some embodiments, a chocolate chip chia granola mass is made comprised of the following:

| | Ingredient | Weight % |
|---|---|---|
| STAGE 1 | Oil | 5-12 |
| | Natural anti-oxidant | 0.1-1.0 |
| | Emulsifier | .1-.4 |
| | Pre-gelatinized starch | 2.0-10.0 |
| | Mix 1 min HIGH | |
| STAGE 2 | Sugar syrup comprising | 1-9 |
| | molasses and medium | |
| | invert cane syrup | |
| | Flavoring comprising vanilla | .1-2.5 |
| | Water | 9-15 |
| | Mix 6 min LOW | |
| STAGE 3 | Grains comprising rolled | 30-60 |
| | grain blend with Quinoa, | |
| | rolled #5 oats, and | |
| | quick oats | |
| | Additives comprising chilled | 5-20 |
| | chocolate chips, whole | |
| | white chia seed, and | |
| | coconut | |
| | Salt | .15-1.2 |
| | Leavening agent | .1-.7 |
| | Mix 1.5 min LOW | |
| STAGE 4 | Additives comprising | 1.0-6.0 |
| | brown rice crisps | |
| | Sugar comprising dried | 10-20 |
| | cane syrup | |
| | Oil | .5-3.5 |
| | Mix 1.5 min LOW | |
| | Total | 100.00 |

The granola mass is thereafter shaped in a rotary molding process to a desired shape.

### Example 5

In accordance with some embodiments, a savory flavor granola mass is made comprised of the following:

| | Ingredient | Weight % |
|---|---|---|
| STAGE 1 | Oil | 0-18 |
| | Emulsifier | .1-.4 |
| | Xanthan gum | .05-5 |
| | Pre-gelatinized starch | 1-10 |
| | Mix 1 min HIGH | |
| STAGE 2 | Sugar syrup comprising | 1-9 |
| | corn syrup | |
| | Sugar | 0-25 |
| | Water | 9-15 |
| | Mix 6 min LOW | |
| STAGE 3 | Grain | 30-60 |
| | Spices | .1-2.5 |
| | Pre-gelatinized starch | 1-10 |
| | Additives comprising flax, | 3-10 |
| | chia, and quinoa seeds | |
| | Salt | .15-1.2 |
| | Leavening agent | .07-.7 |
| | Mix 1.5 min LOW | |
| STAGE 4 | Oil | 1-18 |
| | Mix 1.5 min LOW | |
| | Total | 100.00 |

The granola mass is thereafter shaped in a rotary molding process to a desired shape.

### Example 6

In accordance with some embodiments, a savory granola mass is made comprising the following:

| | Ingredient | Weight % |
|---|---|---|
| STAGE 1 | Sugar syrup comprising | 1-9 |
| | brown rice syrup and | |
| | malt extract | |
| | Hydrocolloid gum | 0.05-0.50 |
| | comprising xanthan gum | |
| | Mix 1.5 min on LOW speed | |
| STAGE 2 | Water | 9-15 |
| | Mix 6 min on LOW speed | |
| STAGE 3 | Flavoring comprising | 0.1-3.0 |
| | herbs and spices | |
| | Salt | 0.15-1.2 |
| | Leavening | 0.1-0.7 |
| | Grains comprising instant | 30-60 |
| | barley flakes, #5 oats, rolled | |
| | grain blend, pre-gel wheat | |
| | berries, and quinoa | |
| | Mix 2.5 min on LOW speed | |
| STAGE 4 | Sugar comprising dried | 0-5 |
| | cane syrup | |
| | Additives/inclusions | 5-20 |
| | comprising pre-cooked | |
| | bean granules and | |
| | grains comprising | |
| | brown crisp rice | |
| | Mix 1.5 minute on | |
| | LOW speed | |
| | Total | 100.00 |

While some embodiments have been particularly shown and described with reference to the foregoing preferred and alternative embodiments, it should be understood by those skilled in the art that various alternatives to the embodiments described herein may be employed in practicing the invention without departing from the spirit and scope of the invention as defined in the following claims. It is intended that the following claims define the scope of the invention and that the methods, systems, and compositions within the scope of these claims and their equivalents be covered thereby. This description of some embodiments should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

1. (canceled)

2. (canceled)

3. A process for making a shaped granola food product, comprising the steps of:
mixing together water and pre-gelatinized starch and/or hydrocolloid gum, and optionally an emulsifier, to form a binder mixture;
adding to and mixing in the binder mixture optionally one or more of an oil portion, a sugar syrup, a leavening agent, salt, a vitamin, and a mineral to form a second mixture;
adding to and mixing in the second mixture grains and optionally one or more leavening agent to form a third mixture;
adding to and mixing in the third mixture sugar and/or other sweetener, an optional additional oil portion, and optionally one or more of an additive and an inclusion to form a fourth mixture comprising a granola mix;
feeding the fourth mixture to a rotary molder; and
forming a shaped granola food product using the rotary molder.

4. The process of claim 3, wherein the ingredients of the respective mixtures comprise the following weight percentages of the fourth mixture:

| | |
|---|---|
| Oil | 0-18% |
| At least one of: | |
| pre-gelatinized | 0-10% |
| starch or | |
| hydrocolloid gum | 0-10% |
| Sugar syrup | 0-20% |
| Flavoring | 0-7.5% |
| Emulsifier | 0-0.5% |
| Water | 8-18% |
| Leavening agent(s) | 0-1% |
| Salt | 0-2.0% |
| Vitamins/minerals | 0-3% |
| Minor additives | 0-3% |
| Grains | 20-65% |
| Leavening agent(s) | 0-1% |
| Sugar/sweeteners | 0-25% |
| Additives/inclusions | 0-35% |
| Additional oil portion | 0-5% |

5. (canceled)

6. (canceled)

7. (canceled)

8. (canceled)

9. (canceled)

10. A process for making a shaped granola food product, comprising the steps of:
mixing together a hydrocolloid gum and a sugar syrup to form a first mixture;
adding to and mixing in the first mixture water to form a second mixture;
adding to and mixing in the second mixture grains, flavoring, salt, and a leavening agent to form a third mixture;
adding to and mixing in the third mixture additives and optionally sugar to form a fourth mixture;
feeding the fourth mixture to a rotary molder; and
forming a shaped granola food product using the rotary molder.

11. The process of claim 10, wherein the hydrocolloid gum comprises xanthan gum.

12. The process of claim 10, wherein the sugar syrup comprises one or more of brown rice syrup and malt extract.

13. (canceled)

14. The process of claim 10, wherein the grains comprise one or more of barley flakes, oats, wheat berries, and quinoa.

15. The process of claim 10, wherein the additives comprise one or more of bean granules and brown crisp rice.

16. The process of claim 10, wherein the ingredients of the respective mixtures comprise the following weight percentages of the fourth mixture:
sugar syrup: 1-9%;
hydrocolloid gum: 0.05-0.5%;
water: 9-15%;
flavoring: 0.1-3.0%;
salt: 0.15-1.2%;
leavening agent: 0.1-0.7%;
grains: 30-60%;
sugar: 0-5%; and
additives: 5-20%.

17. The process of claim 10, further comprising the step of:
baking the shaped granola food product after the forming step.

18. The process of claim 17, further comprising the steps of:
cooling the shaped granola food product after baking, and
packaging the cooled, shaped granola food product.

19. (canceled)

20. (canceled)

21. (canceled)

22. (canceled)

21. (canceled)

22. (canceled)

23. (canceled)

24. (canceled)

25. (canceled)

26. (canceled)

27. A shaped granola food product made from a granola mix produced in accordance with the process of claim 3.
